(19) United States
(12) Patent Application Publication
(10) Pub. No.: US 2026/0021822 A1
(43) Pub. Date: Jan. 22, 2026

(54) DRIVING SUPPORT DEVICE

(71) Applicant: SUBARU CORPORATION, Tokyo (JP)

(72) Inventor: Shinji MATSUSHITA, Tokyo (JP)

(21) Appl. No.: 19/230,298

(22) Filed: Jun. 6, 2025

(30) Foreign Application Priority Data
Jul. 17, 2024 (JP) 2024-113759

(51) Int. Cl. B60W 50/14; B60W 40/08; B60W 50/00

(52) U.S. Cl. CPC B60W 50/14; B60W 40/08; B60W 2050/0083; B60W 2050/143; B60W 2050/146; B60W 2540/22

(57) ABSTRACT

A driving support device includes at least one processor and a storage medium. A program configured to be executed by the at least one processor is stored in the storage medium. The program includes at least one command. The at least one command is configured to cause the at least one processor to execute an emotion determination process, a support determination process, a support type determination process, and a support execution control process. The emotion determination process involves determining an emotion of a driver based on acquired detection information. The support determination process involves determining whether the driver is in a state where driving support is desirable. The support type determination process involves determining a type of the driving support in accordance with the determined emotion when the driving support is desirable. The support execution control process involves executing the determined type of the driving support.

### CROSS-REFERENCE TO RELATED APPLICATIONS

The present application claims priority from Japanese Patent Application No. 2024-113759 filed on Jul. 17, 2024, the entire contents of which are hereby incorporated by reference.

### BACKGROUND

The present disclosure relates to driving support devices equipped in vehicles.

Japanese Unexamined Patent Application Publication (JP-A) No. 2017-136922 describes estimation of an emotion of a driver who drives a vehicle or an emotion of a vehicle occupant, and control of traveling of the vehicle based on the estimated emotion.

JP-A No. 2018-151911 describes a driving support device that can determine whether a driving state is suitable for a driving environment and can feed back a determination result.

### SUMMARY

An aspect of the disclosure provides a driving support device including at least one processor and a storage medium. A program configured to be executed by the at least one processor is stored in the storage medium. The program includes at least one command. The at least one command is configured to cause the at least one processor to execute an emotion determination process, a support determination process, a support type determination process, and a support execution control process. The emotion determination process involves determining an emotion of a driver based on acquired detection information. The support determination process involves determining whether the driver is in a state where driving support is desirable. The support type determination process involves determining a type of the driving support in accordance with the determined emotion when the driving support is desirable. The support execution control process involves executing the determined type of the driving support.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 illustrates the configuration in a vehicle according to an embodiment of the present disclosure;

FIG. 2 illustrates a functional configuration of a driving support device according to the embodiment;

FIG. 3 is a flowchart of a reference value setting process of the driving support device according to the embodiment;

FIG. 4 is a flowchart of a driving support control process according to an embodiment;

FIG. 5 is a flowchart of a driving support control process according to an embodiment;

FIG. 6 illustrates an example of emotion-based driving support control according to the embodiment; and

FIG. 7 illustrates an example of the emotion-based driving support control according to the embodiment.

### DETAILED DESCRIPTION

The emotional state of the driver affects safe driving. For example, there are various human emotions, such as anxiety, fear, irritation, joy, and laughter. However, when these emotions are in an excessive state, safe driving is less likely to be sustained, as compared with a case where a person is driving calmly.

On the other hand, although various driving support techniques have been developed in recent years, it is desirable to perform appropriate driving support in accordance with the degree and extent of emotions.

It is desirable to provide a technique for properly determining the emotional state of the driver to execute appropriate driving support as necessary.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Vehicle Configuration

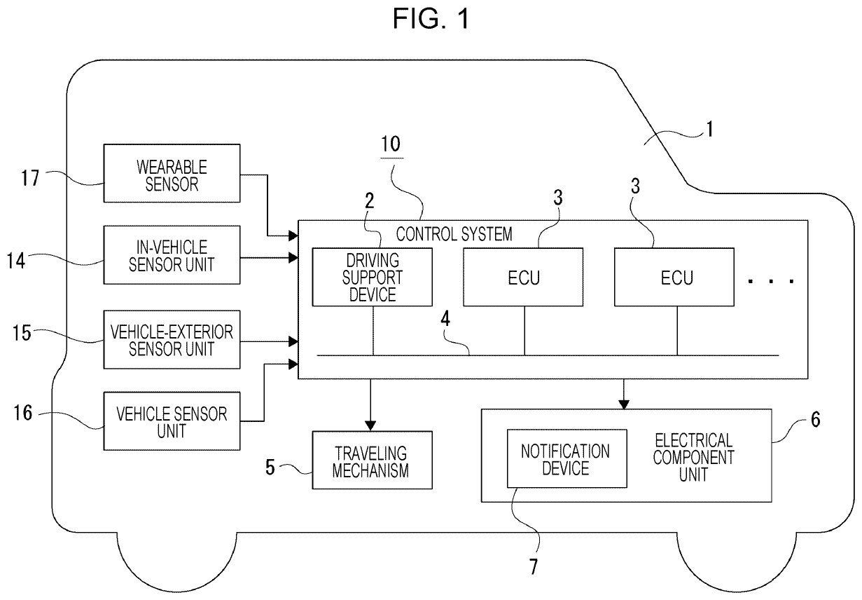

FIG. 1 illustrates a vehicle 1 equipped with a control system 10 including a driving support device 2 according to an embodiment. As the vehicle 1, any of various types of vehicles, such as a gasoline engine vehicle, an electric vehicle, a hybrid vehicle, and a fuel cell vehicle, is assumed.

The vehicle 1 includes the control system 10 including the driving support device 2, a traveling mechanism 5, an electrical component unit 6 including a notification device 7, and various sensors.

FIG. 1 partially illustrates the configuration of the vehicle 1, and it is needless to say that the vehicle 1 includes various components for traveling and driving.

The driving support device 2 includes one or more processors. Specifically, the driving support device 2 includes one or more electronic control units (ECUs) in the vehicle 1. The driving support device 2 may serve as a driving support ECU specialized for a driving support function, or may be realized in other ECU. For example, the ECUs included in the vehicle 1 may include various ECUs, such as a traveling control ECU, a charging control ECU that performs charging control of an in-vehicle battery, an engine control ECU, a display control ECU that performs display control of a display device (including a meter) included in the vehicle 1, an audio output control ECU that performs output control of an audio output device, an automated driving ECU, and an air conditioning control ECU. The driving support device 2 may serve as any of these ECUs in the vehicle.

Each of ECUs 3 illustrated separately from the driving support device 2 indicates an ECU other than the ECU serving as the driving support device 2 among the various ECUs described above.

The driving support device 2 and the other ECUs 3 each include a central processing unit (CPU), a read only memory (ROM), a random access memory (RAM), a nonvolatile memory, and an input/output interface. The CPU executes various processes in accordance with a program stored in the ROM or the nonvolatile memory. The RAM appropriately stores data and the like to be used by the CPU for executing the various processes.

The driving support device 2 and the other ECUs 3 are communicably coupled to one another via a bus 4. For example, the bus 4 is based on controller area network (CAN (registered trademark)) communication, and enables transmission and reception of information between devices.

A software program is installed in each of the driving support device 2 and the ECUs 3 so that a predetermined function can be exhibited.

The operation of each unit is controlled by the control system 10 constituted by the driving support device 2 and the other ECUs 3 within the vehicle 1. That is, the traveling mechanism 5, the electrical component unit 6, the notification device 7, and the like are controlled by the control system 10.

The traveling mechanism 5 comprehensively indicates travel-related components of the vehicle 1. Specifically, the traveling mechanism 5 comprehensively indicates mechanisms related to the traveling operation of an automobile, such as an engine or a motor mechanism, an accelerator mechanism, a brake mechanism, a transmission mechanism, a power steering mechanism, and a suspension mechanism. The traveling mechanism 5 also includes driving operation devices for traveling, such as an accelerator pedal, a brake pedal, a steering wheel, and a shift lever.

The electrical component unit 6 comprehensively indicates all electrical components provided in the vehicle 1. Specifically, assumed examples include an air conditioner, a navigation device, a sound output device, such as a so-called audio device, an interior light, a display device, such as a multi function display (MFD), a power window device, an electric seat mechanism, and a vibration mechanism. The vibration mechanism includes a mechanism that slightly vibrates a driving operation unit, such as a steering wheel and a pedal, and a mechanism that slightly vibrates a seat.

The notification device 7 comprehensively indicates devices capable of providing a notification to the driver in some form, such as text, image, or audio. Examples include a display unit of the MFD or the navigation device as an electrical component, and a sound output unit of the audio device or the navigation device.

The traveling mechanism 5, the electrical component unit 6, and the notification device 7 are illustrated as parts that are caused, by the driving support device 2, to perform some operation or process in accordance with the emotional state of the driver. Specific examples of the traveling mechanism 5, the electrical component unit 6, and the notification device 7 are not limited to those described above.

In FIG. 1, an in-vehicle sensor unit 14, a vehicle-exterior sensor unit 15, a vehicle sensor unit 16, and a wearable sensor unit 17 are illustrated as various sensors.

The in-vehicle sensor unit 14 includes various sensors that detect the condition of occupants in the vehicle cabin of the vehicle 1 and the condition of the interior of the vehicle cabin. For example, the in-vehicle sensor unit 14 includes various sensors that constitute a driver monitoring system (DMS). Specifically, assumed examples include an in-vehicle imaging sensor that detects the driver's facial expressions, line-of-sight direction (eye movement), and blinking, an in-vehicle microphone that acquires voice information from the driver or a vehicle occupant, a pulse sensor that detects the driver's pulse, a body temperature sensor that measures the driver's body temperature, a humidity sensor that detects the driver's perspiration, a temperature sensor that detects the temperature inside the vehicle cabin, and a sensor that detects the seat pressure and the pressure distribution thereof. Other examples that may be provided include a fingerprint sensor in the steering wheel or the like and a voiceprint sensor that detects the driver's voice and analyzes a voiceprint.

The various sensors described above are examples, and the in-vehicle sensor unit 14 may include only one or more of the sensors described above, or may include a sensor other than those described above. The in-vehicle sensor unit 14 may include, for example, a weight sensor and/or a contact sensor to detect the presence or absence of a vehicle occupant.

The vehicle-exterior sensor unit 15 includes various sensors that detect the conditions outside the vehicle 1. For example, the vehicle-exterior sensor unit 15 includes a vehicle-exterior imaging sensor for detecting an object, such as another vehicle including a leading vehicle, a pedestrian, or a lane, existing outside the vehicle, the weather, such as clear weather, rainy weather, or snowy weather, outside the vehicle, and the condition, such as flooding or snow accumulation, an ambient air temperature sensor for detecting the temperature outside the vehicle, and a gradient sensor, such as a gyroscope sensor, for detecting the gradient of the road on which the vehicle is traveling.

As information about another vehicle, such as a leading vehicle, existing outside the vehicle, conditions, such as traffic congestion, cutting-in, a vehicle-to-vehicle distance, and tailgating, can also be determined.

The various sensors described above are examples, and the vehicle-exterior sensor unit 15 may include only one or more of the sensors described above, or may include a sensor other than those described above. For example, the vehicle-exterior sensor unit 15 may include a millimeter wave radar or a sonar for object detection.

The vehicle sensor unit 16 includes various sensors that detect a traveling condition of the vehicle 1 including a state of each part of the vehicle. For example, the vehicle sensor unit 16 includes a vehicle speed sensor for detecting the speed of the vehicle, an acceleration sensor for detecting the acceleration, an engine speed sensor for detecting the engine speed, an accelerator opening sensor for detecting the accelerator opening, a steering angle sensor for detecting the steering angle, a yaw rate sensor for detecting the yaw rate, a tire pressure sensor constituting a tire pressure monitoring system (TPMS), and a global navigation satellite system (GNSS) sensor, such as a global positioning system (GPS) sensor, for receiving information necessary for recognizing the positional information of the vehicle 1. A vehicle traveling operation is based on a driving operation of the driver. That is, the vehicle traveling operation is based on the driving operation performed on any of the driving operation devices, such as the steering wheel, the shift lever, the accelerator pedal, and the brake pedal. The vehicle sensor unit 16 also includes a sensor that detects the operation amount, the number of operations, the operation frequency, and the like of the driver with respect to each of these driving operation devices.

The various sensors described above are examples, and the vehicle sensor unit 16 may include only one or more of the sensors described above, or may include a sensor other than those described above.

Each of the in-vehicle sensor unit 14, the vehicle-exterior sensor unit 15, and the vehicle sensor unit 16 transmits detection information to the control system 10, that is, the driving support device 2 or the other ECUs 3.

The wearable sensor unit 17 indicates a sensor worn by the driver, and is not necessarily provided in the vehicle 1. For example, the wearable sensor unit 17 is a body-mounted sensing device of a wrist watch type. The pulse rate, the respiratory rate, the body temperature, the amount of perspiration, the skin temperature, the brain waves, and the like of the driver can be detected by the wearable sensor unit 17.

Although the wearable sensor unit 17 may be of any type, it is assumed that the wearable sensor unit 17 can detect at least some kind of biological information of the driver and transmit the detected biological information to the driving support device 2.

The driving support device 2 executes driving support control based on the detection information from the in-vehicle sensor unit 14, the vehicle-exterior sensor unit 15, the vehicle sensor unit 16, and the wearable sensor unit 17, and notification information provided from the other ECUs 3. In the present embodiment, in particular, the driving support device 2 determines the emotion of the driver and performs driving support in accordance with the emotional state. The details of the driving support correspond with the determined emotional state.

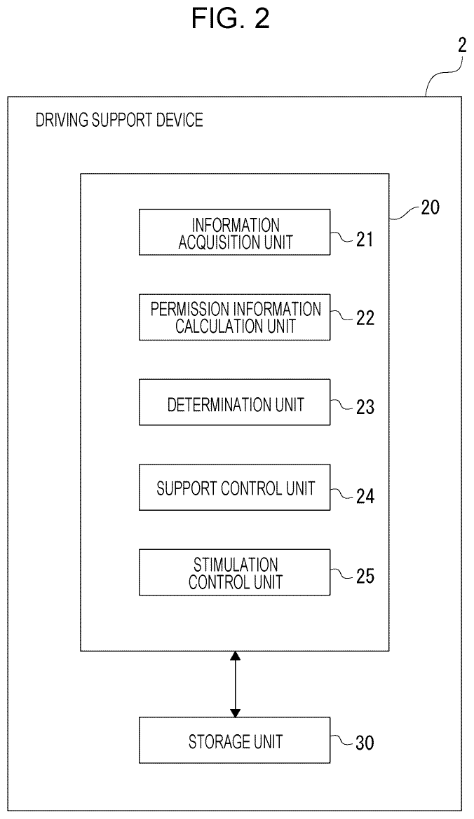

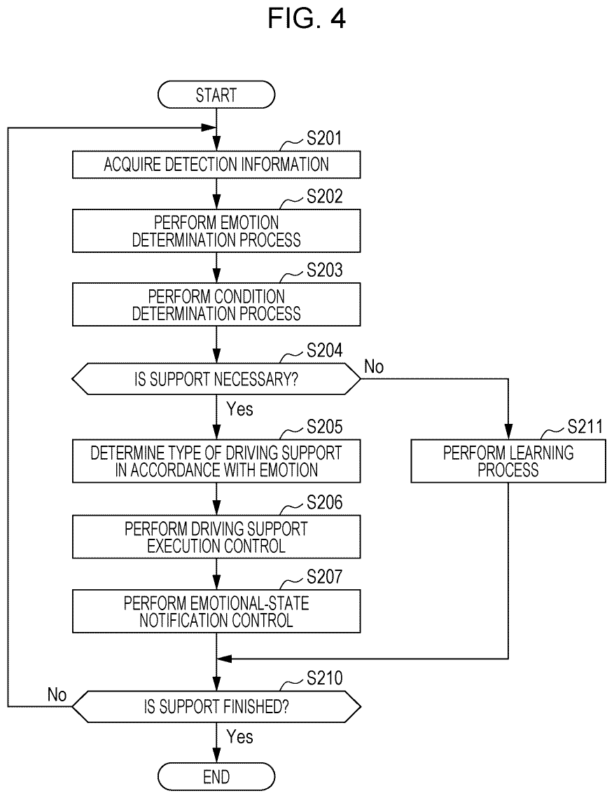

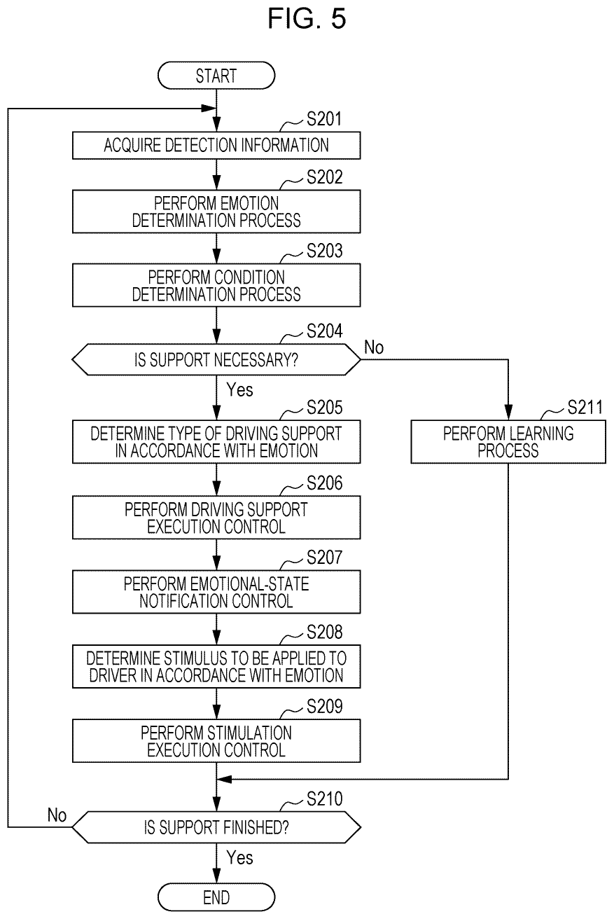

FIG. 2 is a block diagram illustrating functions of a microprocessor serving as the driving support device 2. The microprocessor serving as the driving support device 2 includes an arithmetic unit 20 and a storage unit 30, and the arithmetic unit 20 realizes the illustrated functions in accordance with a program. The functions include functions of an information acquisition unit 21, a permission information calculation unit 22, a determination unit 23, and a support control unit 24. Note that a stimulation control unit 25 will be described later since it is a function related to a process in a second embodiment, to be described later with reference to FIG. 5, and is not necessary for the process in the first embodiment, to be described later with reference to FIG. 4.

A program for causing the arithmetic unit 20 to serve as the information acquisition unit 21, the permission information calculation unit 22, the determination unit 23, the support control unit 24, and the stimulation control unit 25 is stored in, for example, the storage unit 30.

A specific type of the storage unit 30 is not defined. For example, the storage unit 30 may be an internal memory of the microprocessor serving as the driving support device 2, or may be an external memory.

The information acquisition unit 21 has a function of acquiring detection information from the in-vehicle sensor unit 14, the vehicle-exterior sensor unit 15, the vehicle sensor unit 16, and the wearable sensor unit 17 (collectively referred to as “various sensors” hereinafter). The information acquisition unit 21 mainly acquires, from the various sensors, biological information, such as the driver's pulse, respiration rate, body temperature, and perspiration amount, information about the facial expression and the line of sight, information about an operation of a driving operation device, such as the steering wheel, the brake pedal, or the accelerator pedal, by the driver, information about a seat pressure distribution of the driver's seat, and the like as information used for estimating the driver's emotion.

Note that information other than the above-described information may be used to estimate the driver's emotion. For example, information from the vehicle-exterior sensor unit 15, such as information about a surrounding vehicle, information about traffic congestion, weather information, information about the road condition, information about the light condition (e.g., morning light, evening light), night/daytime information, and information about the traveling area, can also be utilized for estimating the emotion.

The permission information calculation unit 22 has a function of calculating, for each individual driver, a permissible range and degree with respect to the detection information acquired from each of the various sensors by the information acquisition unit 21. For example, the upper limit or the range of the biological information, the range of the information about the seat pressure distribution, the range of the driving operation, and the like in a calm emotional state of each individual driver are calculated based on a learning process.

Specifically, the permission information calculation unit 22 sets, based on a learning process, the following examples as the permission information related to the driver's biological information:
an upper limit value for the heart rate;
an upper limit value for the respiratory rate;
an upper limit value for a change in skin temperature;
an upper limit value for an increase in perspiration amount;
an upper limit value for the amount of eyeball movement; and
an upper limit value for blinking frequency.

If these values are lower than or equal to the upper limit values, the information serves as an index for estimating that the emotion or condition of the driver is normal.

Further, the permission information calculation unit 22 sets, based on a learning process, the following examples as the permission information about the seat pressure distribution:
an upper limit value for a difference from an ideal pressure distribution;
an upper limit value for a difference between the pressure distribution at the start of driving and the current pressure distribution;
an upper limit value for a pressure distribution difference between left and right sides or front and rear sides; and
an upper limit value for a deviation in the pressure distribution or a shift in the center of gravity.

If these values are lower than or equal to the upper limit values, the information serves as an index for estimating that the emotional state or condition of the driver is normal.

Further, the permission information calculation unit 22 sets, based on a learning process, the following examples as the permission information related to a driving operation device:
an upper limit value for the number of steering operations per unit time;
an upper limit value for the number of brake/accelerator operations per unit time;
an upper limit value for the brake/accelerator operation frequency with respect to a vehicle-to-vehicle distance relative to a leading vehicle; and
an upper limit value for the brake/accelerator operation frequency with respect to a vehicle-to-vehicle distance relative to a trailing vehicle.

If these values are lower than or equal to the upper limit values, the information serves as an index for estimating that the emotional state or condition of the driver is normal.

The above description is an example, and the permission information that may be set may include other detection information, including an upper limit value or a range related to the vehicle exterior environment, such as traffic congestion or weather.

Although the permission information calculation unit 22 calculates the permission information serving as an index for the emotion determination, as described above, it is assumable that the permission information varies for each individual. Therefore, the permission information calculation unit 22 also performs individual determination of the driver based on the detection information from the various sensors, learns the behavior at the time of driving for each individual, and updates the permission information for each individual.

The permission information as an initial value and the permission information to be updated for each individual by learning are stored in the storage unit 30.

The determination unit 23 performs an emotion determination process of determining the driver's emotion based on the acquired detection information and a support determination process of determining whether the driver is in a state where driving support is necessary. That is, the determination unit 23 estimates the emotion of the driver based on the detection information from the various sensors. Any of various known algorithms can be applied as an emotion estimation algorithm. For emotion estimation, the determination accuracy can be increased by using not only information directly indicating the state and behavior of the driver, such as the biological information, the information about the line of sight, the facial expression, and the like, the driving operation information, and the information about the seat pressure distribution, but also information about the vehicle exterior environment and the like.

The determination unit 23 also determines whether the estimated emotional state (e.g., the degree of anger or the degree of laughter) is at a level at which driving support is necessary. In this case, the determination unit 23 refers to the permission information of the driver, and determines whether the driving support is necessary based on the presence or absence or the number of items exceeding the aforementioned upper limit values.

If the determination unit 23 determines that the driver is in an emotional state where the driving support is necessary, the support control unit 24 determines the type of the driving support operation in accordance with the emotion of the driver, and performs a control process for executing the driving support.

For example, the support control unit 24 issues a command to the ECUs 3 that control the traveling mechanism 5 and the electrical component unit 6 so that the determined driving support operation is performed in the traveling mechanism 5 and the electrical component unit 6.

In addition, the support control unit 24 issues a command to the ECU 3 that controls the notification device 7 to cause the notification device 7 to notify the driver of the emotion.

Although an example of the type of the driving support determined by the support control unit 24 in accordance with the emotion will be described later, the following examples are considered as control targets:
driving force control of the engine/motor;
braking/regenerative braking/accelerator braking and drive command control;
steering characteristic control;
suspension control; and
advanced driver-assistance systems (ADAS) control.

It is assumable to increase the response speed if danger occurs by shifting control threshold values of the above to the higher side or shifting the control time to the shorter side.

### Processing Example of First Embodiment

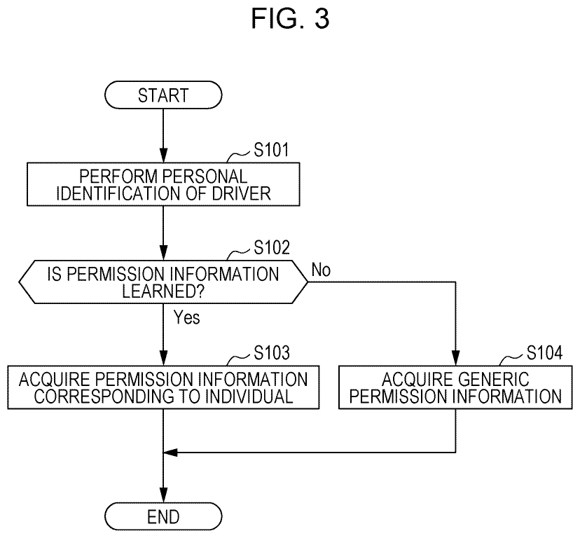

A processing example of the driving support device 2 according to a first embodiment will now be described with reference to FIG. 3 and FIG. 4. A process described below is an example of a process executed by the driving support device 2 with the function of the arithmetic unit 20 described with reference to FIG. 2.

The driving support device 2 performs a process for preparing for the determination in FIG. 3 at a stage where the vehicle 1 starts traveling, such as at a time point immediately after an ignition-on point or a ready-on point.

In step S101, the driving support device 2 performs personal identification of the driver. For example, the driver is identified using face authentication based on driver's face detection information by the in-vehicle sensor unit 14, iris authentication based on an image of an eyeball, fingerprint sensor information, voiceprint information, or the like.

This is personal identification for determining whether the learned permission information is already stored. For example, face information or the like for the personal identification is managed in association with the learned permission information, so that it is possible to determine whether the current driver is a driver corresponding to the learned permission information by collating the face information or the like with the detection information about the current driver.

If the current driver is a driver corresponding to the learned permission information, the driving support device 2 proceeds from step S102 to step S103, reads the permission information of the driver from the storage unit 30, and sets the permission information as permission information to be used in the process in FIG. 4.

If the current driver is a driver not corresponding to the learned permission information, the driving support device 2 proceeds from step S102 to step S104, reads generic permission information from the storage unit 30, and sets the generic permission information as permission information to be used in the process in FIG. 4.

It is desirable that the identification information, such as the face identification information, the iris information, or the fingerprint information, at the time of the personal identification in step S101 be stored in the storage unit 30 and be associated with permission information updated as a result of a subsequent learning process.

FIG. 4 illustrates an example of a process performed by the driving support device 2 during driving. The driving support device 2 repeatedly executes the process in FIG. 4 until it is determined in step S210 that the support process is to be terminated.

In step S201, the driving support device 2 acquires detection information from the various sensors.

In step S202, the driving support device 2 performs a driver's emotion determination process. This is a process in which the driving support device 2 estimates an emotion, such as joy, surprise, anger, fear, or sadness, based on the detection information received from the various sensors. As described above, the emotion can be estimated by mainly using the biological information, the line-of-sight information, the information about the behavior during the driving operation, and the like. In addition, information about the surrounding environment, such as traffic congestion, tailgating, and weather, can be used for the emotion estimation.

In step S203, the driving support device 2 determines the condition of the driver.

This processing example involves determining not only the emotion of the driver but also the condition, such as the physical condition, drowsiness, or fatigue, of the driver at the same time, thereby enabling driving support that further enhances safety. Similarly to the emotion determination, the condition determination can be performed by using the biological information, the line-of-sight information, the information about the behavior during the driving operation, and the like of the driver, so that the condition determination can be performed together with the emotion determination. For example, the degree of physical fatigue can be calculated by calculating the center of gravity or the like of the driver's body from the seat pressure.

In step S204, the driving support device 2 determines whether the determined emotion of the driver is in a state where support is necessary. For example, human emotions, such as joy, surprise, anger, fear, and sadness, have levels, and slight joy or anger does not mean that calm driving is impossible. On the other hand, excessive emotion of joy or laughter leads to careless driving. The same applies to the emotion of anger or fear. It is considered that an increased degree of emotion hinders safe driving.

Therefore, the driving support device 2 compares the detection information from the various sensors acquired for the emotion determination with the permission information acquired in step S103 or step S104 in FIG. 3, and determines whether the state of the emotion is at a level where driving support is necessary. For example, each piece of detection information is compared with the upper limit value of the permission information exemplified above to determine the presence or absence or the number of pieces of detection information exceeding the upper limit value or to determine which detection information exceeds the upper limit value, and it is comprehensively determined whether a determination reference value for the necessity of the support is exceeded.

For example, for each piece of detection information, it is determined whether the set permission information is exceeded, or the amount of excess is determined, and scoring is performed. Then, a predetermined calculation using each score is performed, and it is determined whether the calculation result exceeds the determination reference value for determining whether the support is necessary. In this case, each piece of detection information may be weighted. When the calculation result exceeds the determination reference value, it is determined that the driving support is necessary.

It is also conceivable to reflect the vehicle exterior condition in a determination calculation algorithm in this case. For example, when there is a cutting-in vehicle or the like, the weight of the score related to the emotion of anger is increased.

Further, it is conceivable to take into account the in-vehicle environment, the relationship with a vehicle occupant, and the like. A conceivable example involves the driving support device 2 also performing the emotion determination on a vehicle occupant and lowering the determination reference value or changing the weight of each score if the driver and the vehicle occupant are in a tense situation.

The driving support device 2 also determines the condition of the driver in step S203. Therefore, it may be determined whether the support is necessary in consideration of not only the emotional state of the driver but also the condition. For example, in a case where a poor physical condition or fatigue is determined, the upper limit value for the permission information serving as a criterion for the determination may be lowered so that the support is more likely to be performed. Alternatively, permission information may be set for detection information used for determining a poor physical condition, fatigue, drowsiness, or the like, and it may be determined that the driving support is necessary when the permission information related to the condition is exceeded even if the emotion is normal.

That is, the determination of whether the driving support is necessary may be performed from the viewpoint of the emotion, may be performed in accordance with the determination calculation in which the emotion and the condition are combined, or may be performed from both the viewpoint of the emotion and the viewpoint of the condition.

For example, the driving support device 2 performs the determination of whether the driving support is necessary in the above-described manner in step S204. When the driving support device 2 determines that the support is not necessary, the driving support device 2 proceeds to step S211 to perform a learning process. This is a process involving setting the detection information at that time as data to be learned as a value in a case where the support is not necessary, proceeding with the learning process, and updating the permission information corresponding to the individual driver. For example, the value of each piece of detection information is sequentially stored in the learning process in step S211. Then, at a certain time point in step S211, the process performed may involve performing the learning process using the value of the detection information stored so far, correcting the upper limit value for the permission information with which the driver can perform normal driving, and updating the permission information associated with the driver.

When the driving support device 2 determines that the driving support is necessary in step S204, the driving support device 2 proceeds to step S205 and determines the type of driving support in accordance with the determined emotion. That is, it is determined what kind of driving support control is to be performed. For example, a part to be controlled, a control amount, a control direction (e.g., up direction/down direction), and the like are determined with respect to steering support control, brake support control, accelerator support control, or the like.

Then, in order to perform the determined support control in step S206, the driving support device 2 issues a control command to the ECU 3 that controls the part to be controlled. For example, when the brake support control is to be performed, the driving support device 2 gives instructions about the control details to the ECU 3 that controls the brake mechanism, and causes the ECU 3 to execute control related to the brake mechanism.

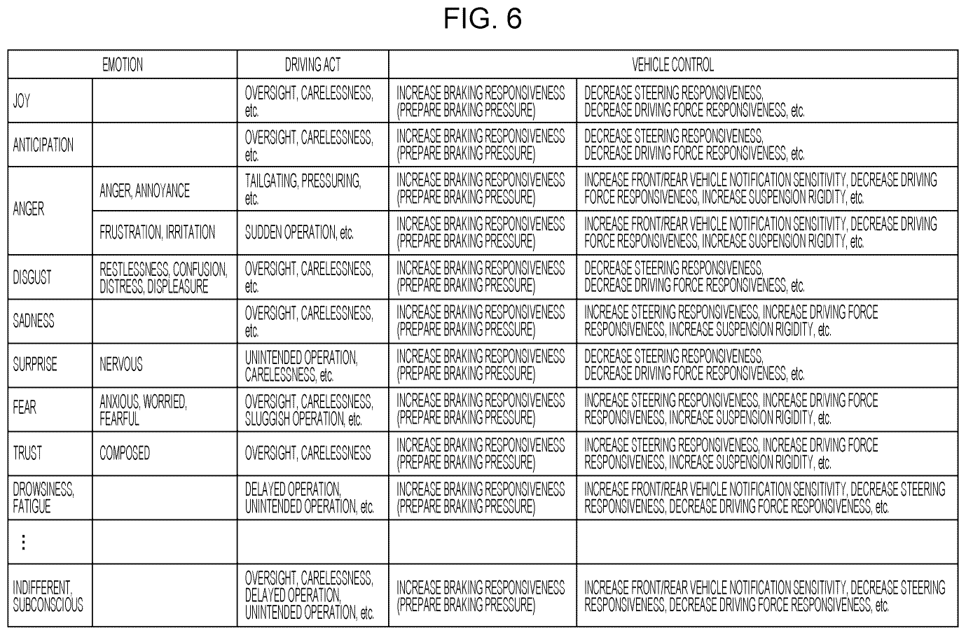

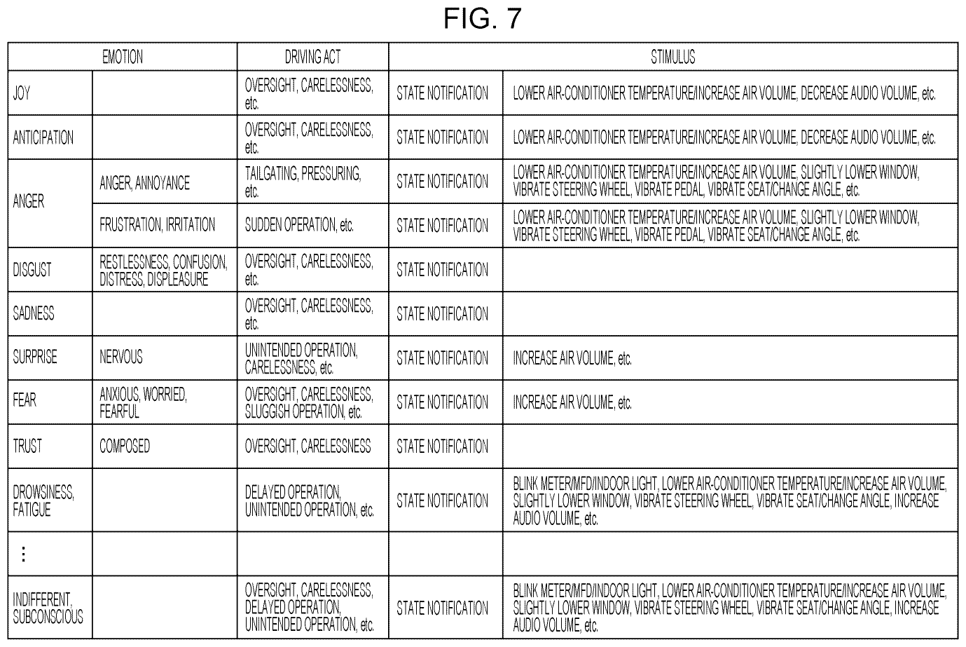

Thus, an appropriate type of driving support is executed in accordance with the emotion of the driver. An example of what kind of support control is performed in accordance with what kind of emotion will be described later with reference to FIG. 6 and FIG. 7.

In step S207 in FIG. 4, the driving support device 2 performs emotion notification control. This is control for notifying the driver of his/her emotion and emotional state. Therefore, the driving support device 2 transmits a command to the ECU 3 that controls the notification device 7, so that notification of the emotion is executed. In response to this command, the ECU 3 for controlling the notification device 7 performs control to cause the notification device 7 to provide a notification about the emotion.

For example, according to the determination of joy, fear, anger, or the like, the driver is notified of an emotion, such as excessive talking or irritation, by using text, an image such as an icon, a voice, or the like. Accordingly, the driver himself or herself is informed of his or her elevated emotion, and is urged to return to calm driving. In addition to the emotion, the driver may be notified of a physical condition, fatigue, drowsiness, or the like.

The driving support device 2 repeats the above process in FIG. 4 until the support ends. The end of the support is, for example, when driving is terminated.

### Processing Example According to Second Embodiment

In a second embodiment, in addition to the first embodiment described above, the driving support device 2 incorporates a process according to the function of the stimulation control unit 25 illustrated in FIG. 2.

The stimulation control unit 25 has a function of controlling an operation for applying a slight stimulus or stress to the driver in accordance with the emotion.

The stimulus in this case includes a visual stimulus by display or light emission, an auditory stimulus by sound, such as audio or voice, and an environmental stimulus in the vehicle cabin by a change in temperature or air volume of an air conditioner, opening of a window, or the like. Further, the stimulus includes a bodily sensation stimulus due to a movement of a seat, a change in a headrest angle, a minute vibration of the steering wheel, and a positional change of a lumbar support. Another conceivable example is olfactory stimulation by spraying an air freshener or the like.

It is known that the human brain causes the body to react to a kind of stress, such as light or sound. In addition, it is known that drowsiness disappears or is alleviated in accordance with exposure to wind through an open window, or pressing of an acupoint. It is also known that the body reacts to a change from a steady state.

It is known that these kinds of slight stress contribute to awakening of the brain. By slightly applying one or a combination of these kinds of stress, it is possible to moderate the emotion or contribute to awakening of the brain, thus promoting safe driving.

The driving support device 2 performs a process in FIG. 5. In the second embodiment, the driving support device 2 performs the process in FIG. 3, and then performs the process in FIG. 5.

In the processing example in FIG. 5, step S208 and step S209 are added to the process in FIG. 4. Since the other processes are the same, the same step numbers are assigned, and redundant descriptions are omitted.

When the driving support device 2 determines that the emotional state requires driving support, the driving support device 2 performs steps S208 and S209 in addition to the process from step S205 to step S207.

In step S208, the driving support device 2 determines the type of stimulus to be applied to the driver in accordance with the determined emotion of the driver.

Then, in step S209, the driving support device 2 commands the ECU 3 that controls a stimulus-applying mechanism to control the mechanism, so that the determined stimulus is applied. For example, when the air volume from the air conditioner is to be changed, the ECU 3 that controls the air conditioner is instructed about the control details, and is caused to execute control for changing the air volume.

Thus, an appropriate type of stimulus application is executed in accordance with the emotion of the driver. An example of what kind of stimulus is applied in accordance with what kind of emotion will be described later.

As described above with reference to FIG. 5, the stimulus application according to the emotion is performed together with the driving support control, thereby prompting the driver to return to the safe emotional state and the awake state.

### Specific Driving Support Example

The following description relates to examples of types of driving support control and types of stimulus application according to various emotions. FIG. 6 illustrates examples of driving support, and FIG. 7 illustrates examples of stimuli to be applied. In addition, in each drawing, examples of types of control when there is drowsiness or fatigue are also illustrated in addition to the emotions.

If the determined emotion is “joy”, there is a concern about oversight, carelessness, or the like as a driving act of the driver. The type of driving support control in this case includes increasing the braking responsiveness. For example, this control involves increasing the brake pressure to improve the braking responsiveness when a brake operation is performed. Another type of driving support control includes decreasing the steering responsiveness and decreasing the driving force responsiveness. These types of control are for preventing an excessive steering operation and an excessive accelerator operation.

Conceivable examples of stimulus application in the case of “joy” include lowering the set temperature of the air conditioner, increasing the air volume of the air conditioner, and reducing the audio volume. That is, the stimulus is applied for calming the driver.

If the determined emotion is “anticipation” as in, for example, a feeling of excitement, there is a concern about oversight, carelessness, or the like as a driving act of the driver. The types of driving support control in this case include increasing the braking responsiveness, decreasing the steering responsiveness, and decreasing the driving force responsiveness.

Conceivable examples of stimulus application in the case of “anticipation” include lowering the set temperature of the air conditioner, increasing the air volume of the air conditioner, and reducing the audio volume.

If the determined emotion is “anger” as in, for example, anger or annoyance against another vehicle, there is a concern about tailgating, pressuring, or the like as a driving act of the driver. Further, in the case of frustration or irritation, there is a concern about a sudden operation, such as sudden steering, sudden starting, or sudden braking, as a driving act of the driver.

The types of driving support control in the case of “anger” include increasing the braking responsiveness, increasing the vehicle notification sensitivity toward the front and/or the rear, decreasing the driving force responsiveness, and increasing the suspension rigidity.

Conceivable examples of stimulus application include lowering the set temperature of the air conditioner, increasing the air volume of the air conditioner, and reducing the audio volume.

If the determined emotion is “disgust”, as in, for example, restlessness, confusion, distress, or displeasure, there is a concern about oversight, carelessness, or the like as a driving act of the driver. The types of driving support control in this case include increasing the braking responsiveness, decreasing the steering responsiveness, and decreasing the driving force responsiveness.

If the determined emotion is “sadness”, there is a concern about a sluggish driving operation as a driving act of the driver. The types of driving support control in this case include increasing the braking responsiveness, increasing the steering responsiveness, increasing the driving force responsiveness, and increasing the suspension rigidity. This is to promote smooth traveling as much as possible against a sluggish driving operation.

If the determined emotion is “surprise”, there is a concern about an unintended driving operation as a driving act of the driver. The types of driving support control in this case include increasing the braking responsiveness, decreasing the steering responsiveness, and decreasing the driving force responsiveness.

A conceivable example of stimulus application includes increasing the audio volume.

If the determined emotion is “fear”, there is a concern about oversight, carelessness, or a sluggish driving operation as a driving act of the driver. The types of driving support control in this case include increasing the braking responsiveness, increasing the steering responsiveness, increasing the driving force responsiveness, and increasing the suspension rigidity.

A conceivable example of stimulus application includes increasing the audio volume.

If the determined emotion is “trust”, as in, for example, an excessive sense of composure, there is a concern about oversight, carelessness, or the like as a driving act of the driver. The types of driving support control in this case include increasing the braking responsiveness, increasing the steering responsiveness, increasing the driving force responsiveness, and increasing the suspension rigidity.

If drowsiness or fatigue is determined in accordance with the condition determination, there is a concern about a delayed driving operation, an unintended driving operation, or the like as a driving act of the driver. The types of driving support control in this case include increasing the braking responsiveness, increasing the vehicle notification sensitivity toward the front and/or the rear, decreasing the steering responsiveness, and decreasing the driving force responsiveness.

Conceivable examples of stimulus application include performing blinking in a meter, an MFD, a room, or the like, lowering the set temperature of the air conditioner, increasing the air volume of the air conditioner, slightly lowering a window, applying vibration, such as steering-wheel vibration, pedal vibration, and seat vibration, changing the seat angle, and increasing the audio volume.

If the determined emotion is “indifferent or subconscious”, there is a concern about oversight, carelessness, a delayed driving operation, an unintended driving operation, or the like as a driving act of the driver. The types of driving support control in this case include increasing the braking responsiveness, increasing the vehicle notification sensitivity toward the front and/or the rear, decreasing the steering responsiveness, and decreasing the driving force responsiveness.

Conceivable examples of stimulus application include the stimulus types similar to the case of drowsiness or fatigue.

Although FIG. 7 illustrates that the “state notification” is performed in the case of any emotion or condition, this indicates that the notification about the emotion or condition is provided by the notification device 7.

### Effects of Embodiment

As described above, the driving support device 2 according to the embodiment executes an emotion determination process of determining the emotion of the driver based on the acquired detection information, a support determination process of determining whether the driver is in a state where driving support is necessary, a support type determination process of determining the type of driving support in accordance with the determined emotion when driving support is necessary, and a support execution control process of executing the determined type of driving support.

Thus, when the driver is conceivably not concentrating on driving calmly and is determined to be in an emotional state where driving support is necessary, driving support suitable for the emotion is executed. This can enhance safety when the emotion of the driver becomes inappropriate for driving.

In particular, the processes according to the embodiments do not simply determine the awake state alone of the driver. In the awake state, the driving act is influenced by the degree of concentration on emotion-based driving even in a state of recognizing that one's consciousness is normal. For example, a brake operation may be delayed, or an accelerator operation or a steering operation may be more aggressive than usual. The present embodiment enables emotion-based support in response to these cases.

The driving support device 2 according to the embodiment executes a notification control process of providing a notification corresponding to the determined emotion of the driver when driving support is necessary.

By providing the notification about the determined emotional state of the driver, the driver can recognize that he/she is not in a normal emotional state. This can arouse the driver to drive consciously with calmness and focus.

As described in the process according to the second embodiment, when driving support is necessary, the driving support device 2 executes a stimulus type determination process of determining the type of stimulus in accordance with the determined emotion and a stimulation execution control process of executing a stimulus application operation of applying the determined type of stimulus to the driver.

In accordance with the determined emotional state of the driver, an appropriate stimulus, such as slight stress according to the emotion, is applied to the driver. This can induce activation of the driver's brain and can cause the driver to return to an emotional state where safe driving is possible.

The driving support device 2 according to the embodiments executes the support determination process including comparing the acquired detection information with the set permission information and determining whether the driving support is necessary by using the comparison result.

A threshold value for each type of detection information in a normal state of the driver is set as permission information, and is compared with each type of detection information during driving. This enables determination with relatively high accuracy of whether the driver is in a normal emotional state for safe driving or in a state where the driving support is necessary.

In the embodiment, the driving support device 2 performs a process of updating the permission information for each individual driver in accordance with the learning process.

Since the permission information varies from individual to individual, the detection information in the normal emotional state is learned and the permission information is updated for each driver. Consequently, emotion determination reflecting individual differences can be performed.

According to the embodiments of the present disclosure, after the emotion is determined and it is determined whether the emotional state is a state where driving support is necessary, the driving support selected in accordance with the emotion is performed. Accordingly, appropriate driving support according to the emotion is executed at an appropriate timing corresponding to the emotional state, thereby contributing to the promotion of safe driving.

The driving support device 2 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the driving support device 2 including the arithmetic unit 20 and the storage unit 30. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A driving support device comprising:
at least one processor; and
a storage medium in which a program configured to be executed by the at least one processor is stored,
wherein the program comprises at least one command, the at least one command being configured to cause the at least one processor to execute:
an emotion determination process of determining an emotion of a driver based on acquired detection information;
a support determination process of determining whether the driver is in a state where driving support is desirable;
a support type determination process of determining a type of the driving support in accordance with the determined emotion when the driving support is desirable; and
a support execution control process of executing the determined type of the driving support.

2. The driving support device according to claim 1,
wherein the at least one command is configured to, when the driving support is desirable, cause the at least one processor to execute a notification control process of providing to the driver a notification according to the determined emotion.

3. The driving support device according to claim 1,
wherein the at least one command is configured to, when the driving support is desirable, cause the at least one processor to execute:
a stimulus type determination process of determining a type of a stimulus in accordance with the determined emotion; and
a stimulation execution control process of executing a stimulus application operation of applying the determined type of the stimulus to the driver.

4. The driving support device according to claim 1,
wherein the at least one command is configured to cause the at least one processor to execute the support determination process comprising a process of comparing the acquired detection information with set permission information and determining whether the driving support is desirable by using a comparison result.

5. The driving support device according to claim 2,
wherein the at least one command is configured to cause the at least one processor to execute the support determination process comprising a process of comparing the acquired detection information with set permission information and determining whether the driving support is desirable by using a comparison result.

6. The driving support device according to claim 3,
wherein the at least one command is configured to cause the at least one processor to execute the support determination process comprising a process of comparing the acquired detection information with set permission information and determining whether the driving support is desirable by using a comparison result.

7. The driving support device according to claim 4,
wherein the at least one command is configured to cause the at least one processor to execute a process of updating the permission information for each driver in accordance with a learning process.

8. The driving support device according to claim 5,
wherein the at least one command is configured to cause the at least one processor to execute a process of updating the permission information for each driver in accordance with a learning process.

9. The driving support device according to claim 6,
wherein the at least one command is configured to cause the at least one processor to execute a process of updating the permission information for each driver in accordance with a learning process.
